(19) United States
(12) Patent Application Publication
(10) Pub. No.: US 2017/0225509 A1
(43) Pub. Date: Aug. 10, 2017

(54) Tire Traction and Vehicle Turning Device

(71) Applicant: Malcolm F. Blackshaw, Wheaton, IL (US)

(72) Inventor: Malcolm F. Blackshaw, Wheaton, IL (US)

(21) Appl. No.: 15/425,819

(22) Filed: Feb. 6, 2017

Related U.S. Application Data
(60) Provisional application No. 62/291,240, filed on Feb. 4, 2016.

(51) Int. Cl. B60B 15/26; B60C 27/02

(52) U.S. Cl. CPC B60B 15/266; B60C 27/0207

(57) ABSTRACT

A tire traction and vehicle turning device attaches to a tire of a vehicle to dislodge the vehicle from unfavorable ground conditions, such as snow, ice, or sand. The tire traction and vehicle turning device includes a tire-mounting body, a plurality of gripping treads, and a tie-down. The tire-mounting body attaches to a tire of the vehicle. The plurality of gripping treads provides a separate surface for the vehicle to gain traction due to differing coefficients of friction between the plurality of gripping treads and the grounds surface compared to the tire and the ground surface. The tie-down is positioned through the rim of the wheel to secure the tire-mounting body to the tire. As the tire is rotated, the tire traction and vehicle turning device is positioned between the ground surface and the tire, lifting the vehicle and propelling the vehicle in the direction the rotating tire is pointing.

The current application claims a priority to the U.S. Provisional Patent application Ser. No. 62/291,240 filed on Feb. 04, 2016. The current application is filed on Feb. 6, 2017 while Feb. 4, 2017 was on a weekend.

### FIELD OF THE INVENTION

The present invention relates generally to vehicle tire traction. More specifically, the present invention relates to a device that attaches to the tire of a motor vehicle in order to provide traction when the motor vehicle is stuck on ice, snow, mud, sand, etc. due to the loss of traction.

### BACKGROUND OF THE INVENTION

Vehicle tires are typically a rubberized cover that protects an inflatable tube from damage while also providing better vehicle performance. The tire provides traction between the wheel and road, while the inflatable tube is a flexible cushion that supports, absorbs shock, and mitigates vibration during the operation of the vehicle. The tire includes grooves on the exterior used to increase traction for varying road conditions. Even with tread, vehicles have a chance to get stuck on ice or in the snow, mud, and sand, as the tires are unable to maintain a firm grip on the surface beneath it. Currently, apparatuses have been developed to attach to tire, such as snow chains, to improve the traction on these surfaces. While snow chains are effective, they are often difficult to attach and remove. When snow chains are not available, individuals make use of boards, planks, or other objects against the bottom of a tire providing leverage or a clean surface for traction to dislodge the vehicle. While potentially effective, the effectiveness of these devices is inconsistent during implementation, as these objects often break due to the weight of the vehicle or slide out of position due to the rotation of the tires and lack of traction with the unfavorable surface.

Therefore, an objective of the present invention is to present a tire traction apparatus to dislodge a vehicle from unfavorable ground-surface conditions. The present invention is particularly useful where a front-wheel, four-wheel, or all-wheel drive vehicle is egressing from a confined parking location, when other vehicles are parked closely to the front and rear of the front-wheel, four-wheel, or all-wheel drive vehicle. The present invention easily attaches to and detaches from a wheel and tire of a vehicle. The present invention is used to provide sufficient traction to dislodge the vehicle from a position in low friction areas covered in ice, snow, mud, sand, etc. The present invention is positioned around a portion of a vehicle's driving tire utilizing a tie-down that passes through the spokes of the wheel rim, to which the tire is connected, in order to keep the present invention attached to the tire. The present invention works when the wheel is turning either forward or in reverse, and when the vehicle's wheels are turned to the right or left, even at relatively acute angles. Overall, the present invention provides a cheap, simple, safe, and effective solution to dislodge a front-wheel, four-wheel, or all-wheel drive motor vehicle from being stuck on unfavorable ground conditions while other vehicles are parked closely to the front and rear of the motor vehicle without assistance from a tow truck.

### BRIEF DESCRIPTION OF THE DRAWINGS

FIG. 1 is a top perspective view of the present invention.

FIG. 2 is a bottom perspective view of the present invention, wherein the tie-down is removed.

FIG. 3 is a front view of the present invention, wherein the tie-down is removed.

FIG. 4 is a rear view of the present invention, wherein the tie-down is removed.

FIG. 5 is a top view of the present invention, wherein the tie-down is removed.

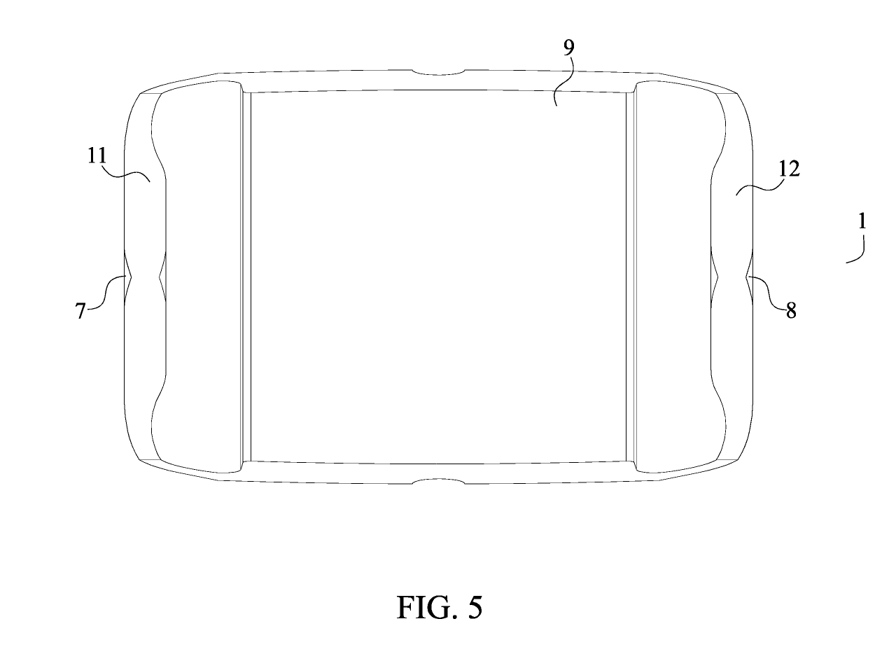

FIG. 6 is a bottom view of the present invention.

FIG. 7 is a left view of the present invention, wherein the tie-down is removed.

FIG. 8 is a right view of the present invention, wherein the tie-down is removed.

FIG. 9 is an illustration of the present invention attached to the front wheel of a vehicle.

FIG. 10 is an illustration for an application of the present invention assisting a vehicle in egressing from a confined parking location with unfavorable ground-surface conditions.

### DETAIL DESCRIPTIONS OF THE INVENTION

All illustrations of the drawings are for the purpose of describing selected versions of the present invention and are not intended to limit the scope of the present invention.

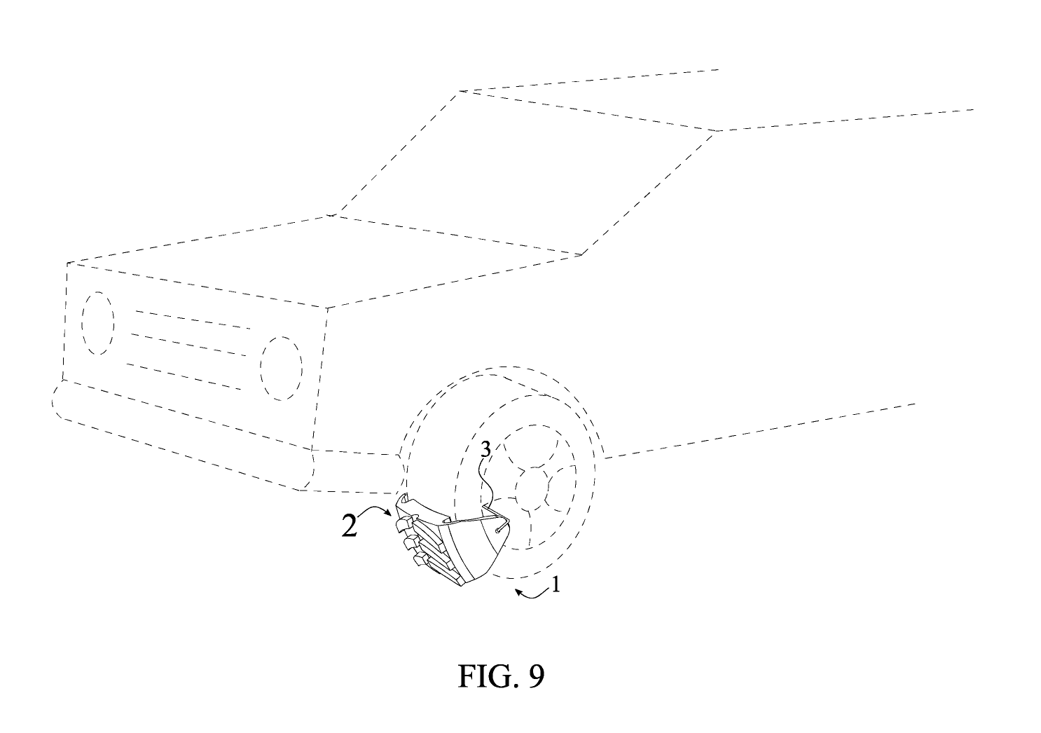

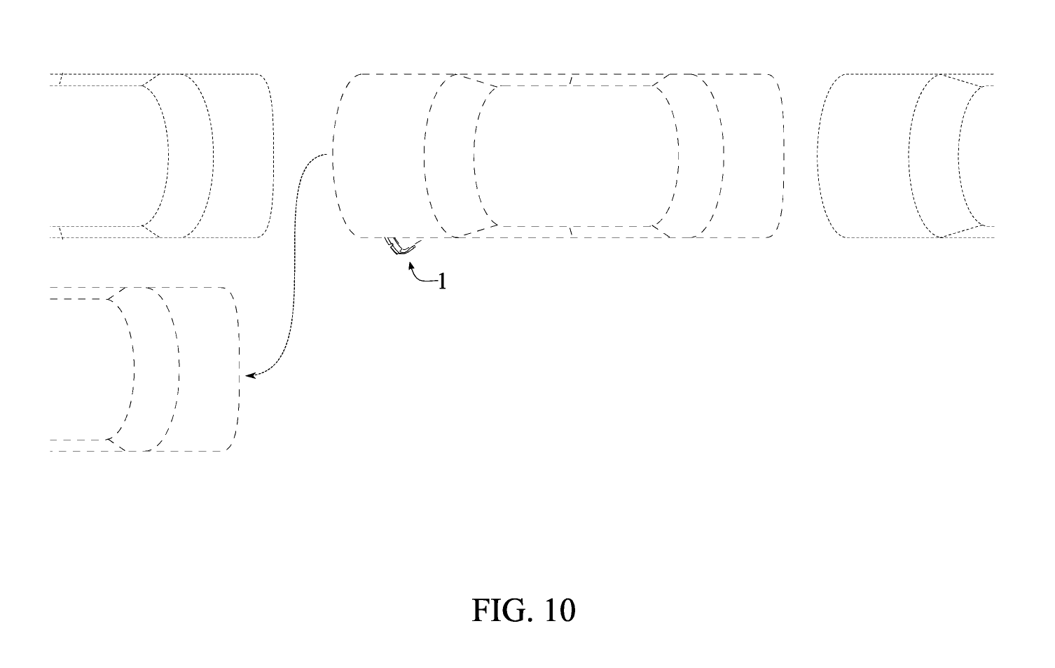

The present invention is a tire traction and vehicle turning device. The present invention engages a driving tire, as shown in FIG. 9, for a front-wheel, four-wheel, or all-wheel drive vehicle to dislodge the vehicle from an unfavorable ground condition, such as ice, snow, sand, mud or similar ground conditions. When attached to a front wheel, the present invention assists the vehicle from egressing from confined parking locations, such as when other vehicles are parked closely to the front and rear of the vehicle, as illustrated in FIG. 10. The present invention rotates with the actuation of a driving tire to raise the vehicle. As the present invention contacts the ground surface, and is positioned between the ground surface and the driving tire during the rotation of the tire, the vehicle is lifted due to the thickness of the present invention. The vehicle is then propelled forward due to the coefficient of friction between the present invention and the ground surface being higher than the coefficient of friction between the tire and the same ground surface. Thus, the present invention provides more traction for the vehicle and allows the present invention to displace loose snow, mud, sand, etc. to egress from a confined parking location.

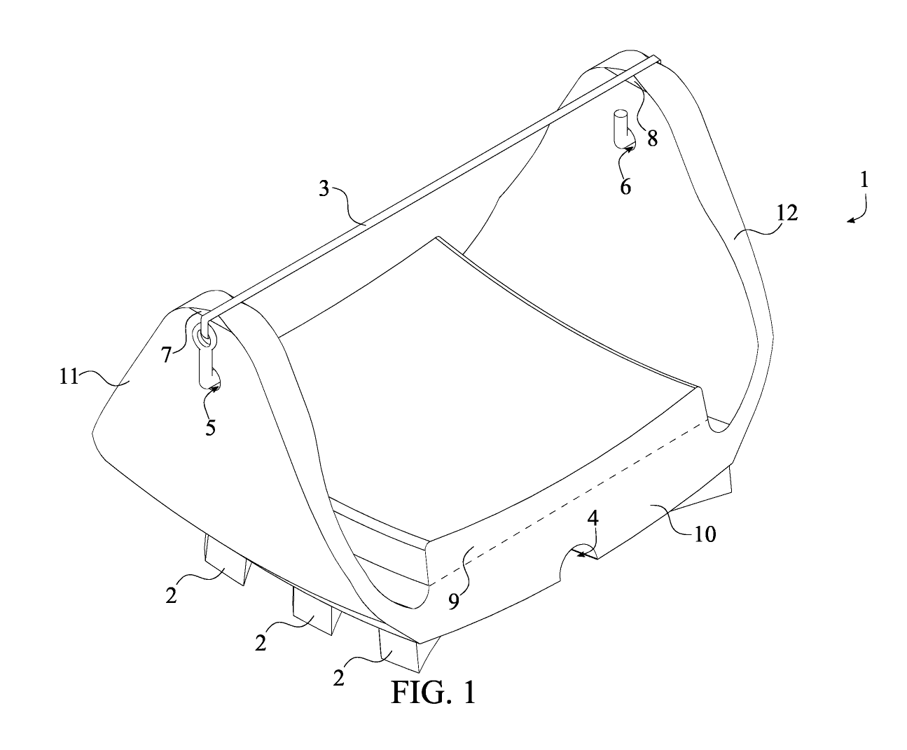

In accordance to FIG. 1, the present invention comprises a tire-mounting body 1, a plurality of gripping treads 2, and a tie-down 3. The tire-mounting body 1 is secured to a driving tire to lift the vehicle when the tire-mounting body 1 is rotated with the tire, wherein the tire-mounting body 1 is positioned between the tire and the ground surface.

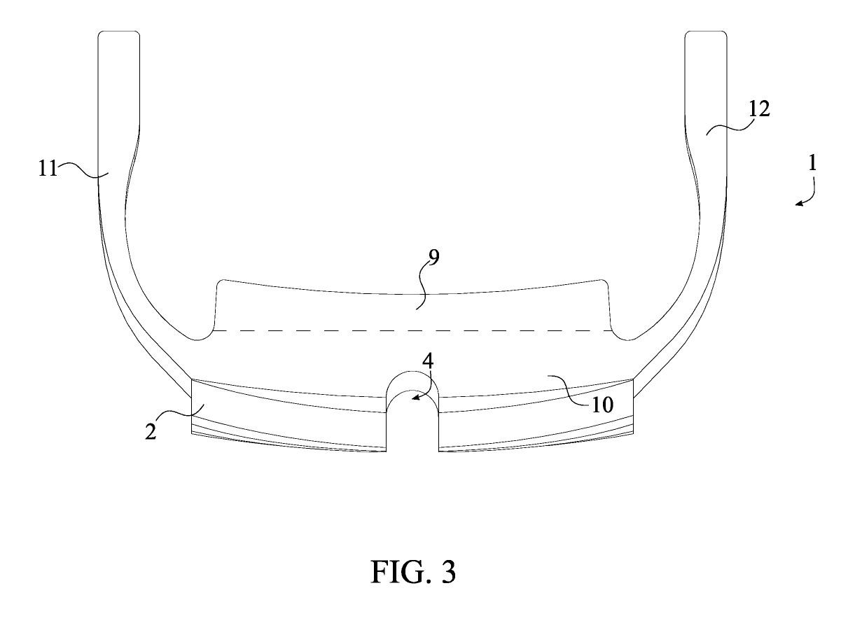

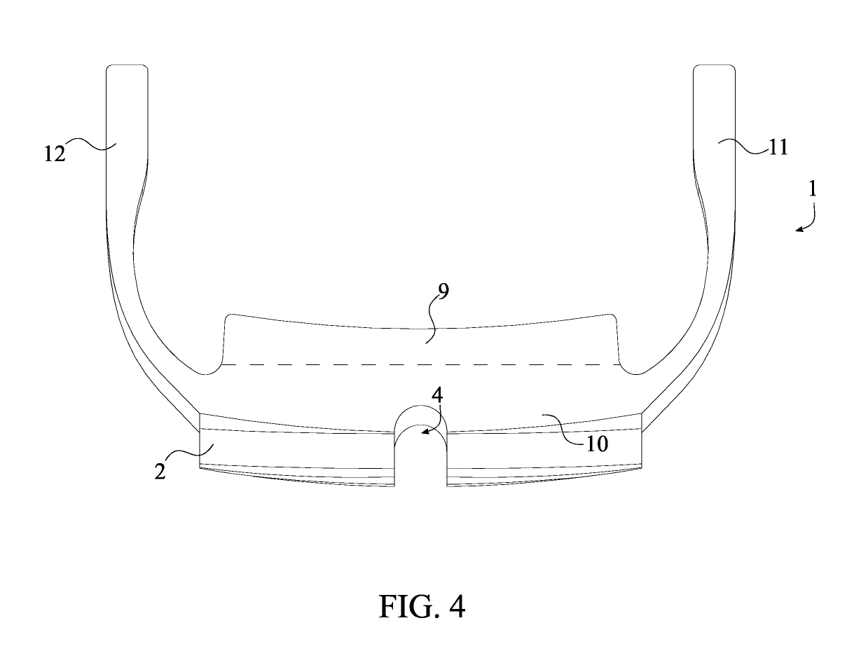

The tire-mounting body 1 comprises a tire-support base 10, a first rim panel 11, and a second rim panel 12, shown in FIG. 1, FIG. 3 and FIG. 4. The tire-support base 10 provides support for the tire and thickness to raise the tire from the ground surface. The first rim panel 11 and the second rim panel 12 assist in providing support for the present invention against a sidewall of the tire by applying pressure to the sidewall when the present invention is secured to the tire. The first rim panel 11 is adjacently connected to the tire-support base 10. The second rim panel 12 is adjacently connected to the tire-support base 10. The first rim panel 11 and the second rim panel 12 are positioned opposite to each other across the tire-support base 10 in order to allow a tire to be positioned between the first rim panel 11 and the second rim panel 12 and pressed against the tire-support base 10. The first rim panel 11 and the second rim panel 12 are preferred to be tapered from the tire-support base 10 to maintain structural integrity while limiting the necessary material for construction.

The plurality of gripping treads 2, shown in FIG. 1 to FIG. 4 and FIG. 6 to FIG. 8, increase the coefficient of friction between the ground surface and the present invention to gain traction, as the plurality of gripping treads 2 is preferred to be made from a material with a higher coefficient for specific applications than traditional tires. The plurality of gripping treads 2 enables the present invention to grip at a wide variety of angles as the wheel, which the present invention is attached, is turned to the left or right for a vehicle egressing from a parked location. The plurality of gripping treads 2 also displaces loose particles of the ground surface, such as snow or sand, when the plurality of gripping treads 2 is rotated onto the ground surface in order for the vehicle to gain traction with the ground surface. The plurality of gripping treads 2 is adjacently connected to the tire-support base 10. In accordance to FIG. 3 and FIG. 4, the plurality of gripping treads 2 is positioned between the first rim panel 11 and the second rim panel 12. The plurality of gripping treads 2 is oriented opposite to the first rim panel 11 and the second rim panel 12 about the tire-support base 10, in order for the plurality of gripping treads 2 to interface with the ground surface when the present invention is positioned on the tire and the present invention is rotated with the tire onto the ground surface.

The tie-down 3, exemplified in FIG. 1, is a cord, rope, or chain used to secure the present invention to the tire. The tie-down 3 is selectively engaged to the first rim panel 11 and the second rim panel 12 in order to allow the user to easily attach the present invention to or remove the present invention from the tire. The tie-down 3 is positioned opposite to the tire-support base 10 along the first rim panel 11 and the second rim panel 12 to allow the user to position the tie-down 3 through spokes of the rim of the tire to secure the present invention to the tire. The tie-down 3 is preferred to be an elastic cord with enough elasticity to be pulled through the rim of the tire and easily connected between the first rim panel 11 and the second rim panel 12; however, the elastic cord is rigid enough that the elastic cord does not significantly deform from the rotation of the tire to maintain the connection between the present invention and the tire as the present invention contacts the ground surface when rotated with the tire. The first rim panel 11 and the second rim panel 12 allow the present invention to be easily attached and secured to the tire. The first rim panel 11 and the second rim panel 12 restrict the orientation of the present invention with respect to the wheel, in order to prevent the present invention from twisting underneath the wheel and potentially damaging the tire.

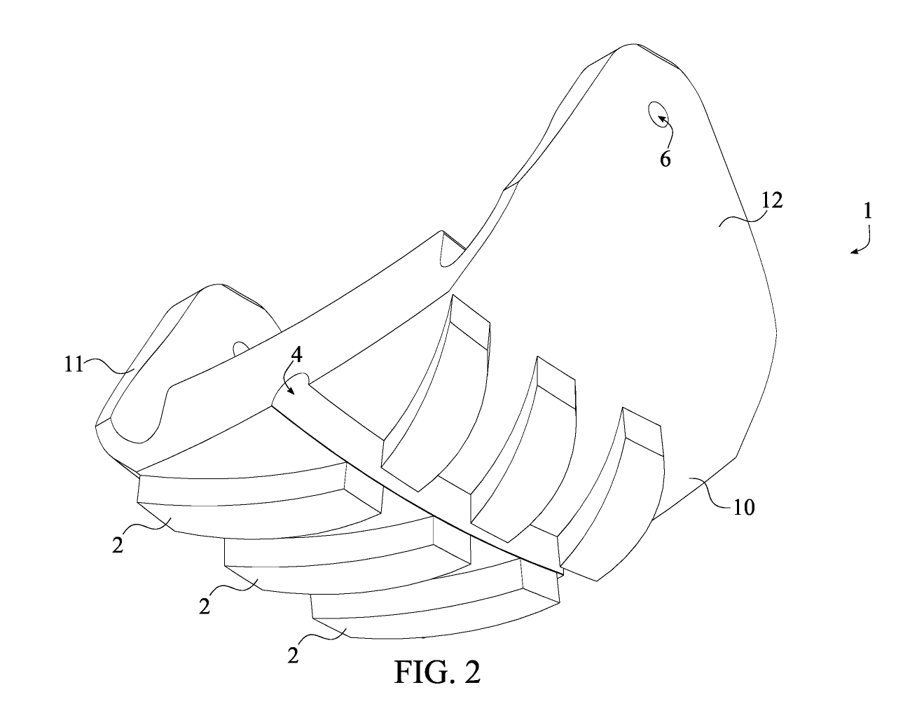

In accordance to the preferred embodiment of the present invention, the present invention comprises a debris channel 4, as shown in FIG. 2 to FIG. 4 and FIG. 6. The debris channel 4 allows debris, solid particles such as sand, snow, sleet, etc., and fluids, such as water and oil, on the ground surface to be effectively displaced from the contact of the plurality of gripping treads 2 with the ground surface to prevent the present invention from slipping on the debris or hydroplaning on the fluid. The debris channel 4 traverses into the tire-support base 10 to provide sufficient room for the displacement of debris and fluids. The debris channel 4 centrally traverses through each of the plurality of gripping treads 2, allowing the plurality of gripping treads 2 to funnel the debris and fluids into the debris channel 4.

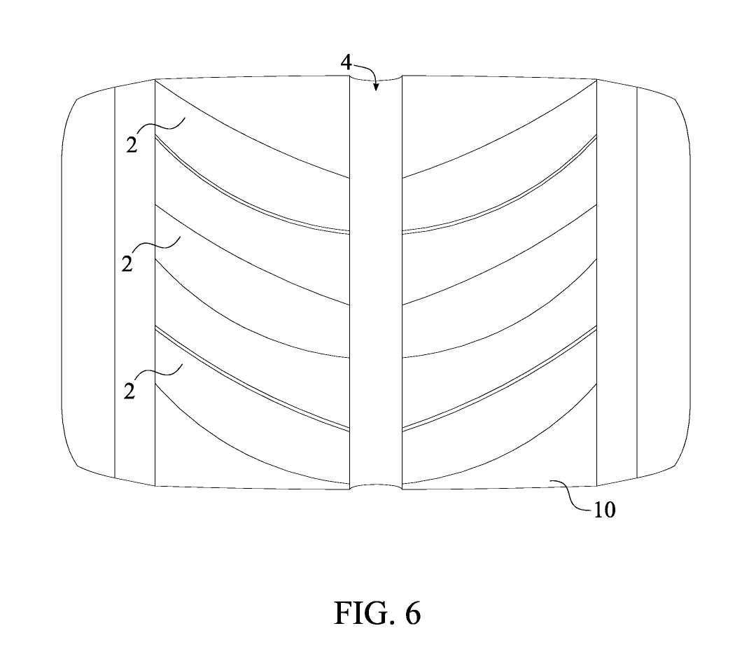

As detailed in FIG. 2 and FIG. 6, the plurality of gripping treads 2 arc between the first rim panel 11 and the second rim panel 12. Arcing the plurality of gripping treads 2 maximizes the surface area for each of the plurality of gripping treads 2 to effectively displace excess debris and fluids on the ground surface and provide consistent traction across the present invention, even when the wheel that the present invention is attached is turned. Each of the plurality of gripping treads 2 is radially offset from each other to allow for sufficient space for the debris to accumulate between each of the gripping treads. A subsequent gripping tread of the plurality of gripping treads 2, with respect to the rotation of the tire when the present invention is mounted on the tire, forces the debris and fluid away from the ground surface adjacent to the tire when the wheel is rotated.

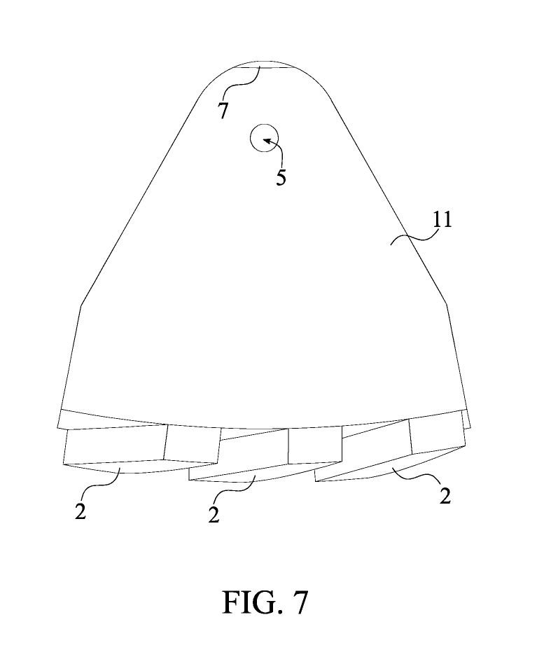

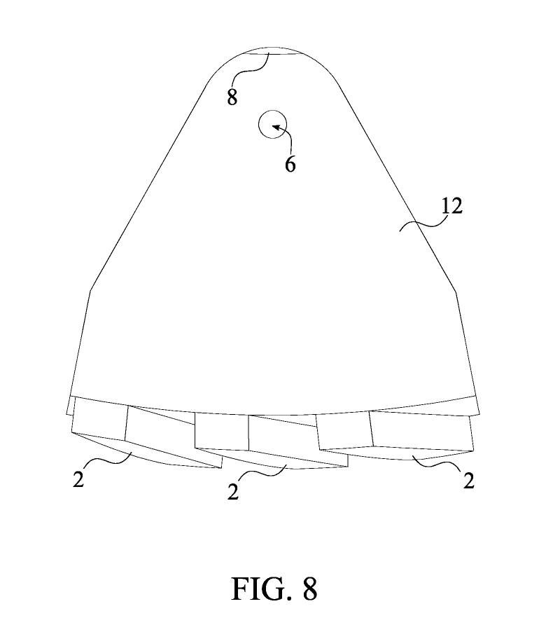

In order to secure the tie-down 3 to the first rim panel 11, the present invention comprises a first cord-receiving hole 5, shown in FIG. 1 and FIG. 7. The first cord-receiving hole 5 provides a fixture point for connecting the tie-down 3 to the first rim panel 11. The first cord-receiving hole 5 traverses through the first rim panel 11. The first cord-receiving hole 5 is positioned opposite to the tire-support base 10 along the first rim panel 11. The tie-down 3 engages the first cord-receiving hole 5. Similarly, the present invention comprises a second cord-receiving hole 6, shown in FIG. 1 and FIG. 8. The second cord-receiving hole 6 provides a fixture point for connecting the tie-down 3 to the second rim panel 12. The second cord-receiving hole 6 traverses through the second rim panel 12. The second cord-receiving hole 6 is positioned opposite to the tire-support base 10 along the second rim panel 12. The tie-down 3 similarly engages the second cord-receiving hole 6. This configuration allows the tie-down 3 to be secured to the first rim panel 11 and the second rim panel 12.

In some embodiments of the present invention, the present invention comprises an extruded tire support 9, in accordance to FIG. 1, FIG. 3 and FIG. 4. The extruded tire support 9 provides additional thickness between the ground surface and the tire in order to lift the tire farther while the present invention contacts the ground surface during the rotation of the tire when the present invention is attached to the tire. The extruded tire support 9 is adjacently connected to the tire-support base 10. The extruded tire support 9 is positioned opposite to the plurality of gripping treads 2 about the tire-support base 10 to increase the height of the tire when the present invention is in contact with the ground surface during the rotation of the tire. Although the invention has been explained in relation to its preferred embodiment, it is to be understood that many other possible modifications and variations can be made without departing from the spirit and scope of the invention as hereinafter claimed.

What is claimed is:

1. A tire traction and vehicle turning device comprises:
a tire-mounting body;
a plurality of gripping treads;
a tie-down;
the tire-mounting body comprises a tire-support base, a first rim panel, and a second rim panel;
the first rim panel being adjacently connected to the tire-support base;
the second rim panel being adjacently connected to the tire-support base;
the first rim panel and the second rim panel being positioned opposite to each other across the tire-support base;
the plurality of gripping treads being adjacently connected to the tire-support base;
the plurality of gripping treads being positioned between the first rim panel and the second rim panel;
the tie-down being selectively engaged to the first rim panel and the second rim panel; and
the tie-down being positioned opposite to the tire-support base along the first rim panel and the second rim panel.

2. The tire traction and vehicle turning device, as claimed in claim 1, comprises:
the plurality of gripping treads being oriented opposite to the first rim panel and the second rim panel about the tire-support base.

3. The tire traction and vehicle turning device, as claimed in claim 1, comprises:
a debris channel;
the debris channel traversing into the tire-support base; and
the debris channel centrally traversing through each of the plurality of gripping treads.

4. The tire traction and vehicle turning device, as claimed in claim 1, comprises:
a first cord-receiving hole;
the first cord-receiving hole traversing through the first rim panel; and
the first cord-receiving hole being positioned opposite to the tire-support base along the first rim panel.

5. The tire traction and vehicle turning device, as claimed in claim 4, comprises:
the tie-down engaging the first cord-receiving hole.

6. The tire traction and vehicle turning device, as claimed in claim 1, comprises:
a second cord-receiving hole;
the second cord-receiving hole traversing through the second rim panel; and
the second cord-receiving hole being positioned opposite to the tire-support base along the second rim panel.

7. The tire traction and vehicle turning device, as claimed in claim 6, comprises:
the tie-down engaging the second cord-receiving hole.

8. The tire traction and vehicle turning device, as claimed in claim 1, comprises:
the first rim panel and the second rim panel being tapered from the tire-support base.

9. The tire traction and vehicle turning device, as claimed in claim 1, comprises:
the plurality of gripping treads arcing between the first rim panel and the second rim panel; and
each of the plurality of gripping treads being radially offset from each other.

10. The tire traction and vehicle turning device, as claimed in claim 1, comprises:
an extruded tire support;
the extruded tire support being adjacently connected to the tire-support base; and
the extruded tire support being positioned opposite to the plurality of gripping treads about the tire-support base.

11. The tire traction and vehicle turning device, as claimed in claim 1, wherein the tie-down is an elastic cord.
